(19) United States
(12) Patent Application Publication
(10) Pub. No.: US 2007/0026214 A1
(43) Pub. Date: Feb. 1, 2007

(54) Thermal management system for high temperature events

(76) Inventors: Daniel E. Bullock, North Attleborough, MA (US); Sara E. Rosenberg, Ashland, MA (US); Christopher M. Comeaux, Worcester, MA (US)

Correspondence Address: ASPEN AEROGELS INC.;IP DEPARTMENT, 30 FORBES ROAD, BLDG. B, NORTHBOROUGH, MA, 01532, US

(21) Appl. No.: 11/328,626

(22) Filed: Jan. 9, 2006

Related U.S. Application Data
(60) Provisional application No. 60/642,208, filed on Jan. 7, 2005.

(51) Int. Cl. B32B 13/02; E04B 1/74; B28B 3/00

(52) U.S. Cl. 428/294.7; 428/331; 264/640; 252/62

(57) ABSTRACT

The present invention describes thermal management systems for high temperature events comprising: an insulating layer having opposing front face and back face, and comprising at least one layer of fiber-reinforced aerogel, said insulating layer disposed about and conforming to a surface to be insulated.

### CROSS-REFERENCES TO RELATED APPLICATIONS

This application claims benefit of priority from U.S. Provisional Patent Application 60/642,208 filed Jan. 7, 2005 and is hereby incorporated by reference in its entirety.

### STATEMENT REGARDING FEDERALLY SPONSORED RESEARCH OR DEVELOPMENT

This invention was partially made with Government support under Contract N65540-04-C-008 awarded by the United States Navy. The Government may have certain rights in parts of this invention.

### FIELD OF INVENTION

This invention generally relates to systems and methods for protecting surfaces against high temperature thermal events.

### DESCRIPTION

A thermal management system is often necessary to insulate surfaces where high thermal events may occur either to assure safety of individuals, secure integrity of structural components, to obstruct spread of fires or other reasons. High thermal events may be exemplified by heat liberated from: explosion of faulty gas lines, detonation of explosives and fuel ignitions. To date, several actual scenarios involved major fires aboard navy vessels and jeopardized structural integrity of the vessel as well as safety of the crew. In the past, some solutions to this problem have been presented but with considerable room for improvement in install-ability, weight, thermal performance and space required among others. Currently, as a thermal management system for some navy vessels, Structo-Gard® (a fibrous material from Thermal Ceramics inc.) and Dendamix™ are used for composite and steel sections respectively.

During a high temperature event, metallic bulkheads and decks “spread fire” by heat transfer which increases the temperature on the cold side above the ignition temperature of common combustibles in adjacent and overhead compartments. The U.S. Navy performance criteria for such insulation is that cold side average temperature rise should not exceed 250° F. above the ambient when tested under the conditions of UL-1709 fire (UL-1709 fire is 2000F and approximately 200 kW/m² heat flux for 30 minutes or more).

A thermal management system comprising aerogels can provide significant improvement in weight reduction, space conservation, superior thermal protection, among other benefits. For instance, Structogard® and Denamix™ typically show a density of about 8 and 12 lb/ft³ respectively whereas aerogels are at about 6 lb/ft³. Furthermore the thermal conductivity of aerogels is typically at most half of either of Structogard® and Denamix™ which translates into less thickness required to achieve the same insulation value (R-value.) Furthermore, considering the lower installation cost (per unit area) of aerogels versus Structogard® or Denamix™, an overall reduction of weight, space and cost can be achieved with equally, if not better, thermal insulation performance. Furthermore aerogel materials can be installed with equal facility as Structogard® or Denamix™ while maintaining comparable lifetime performance (15-20 yrs) and without any health risks.

It is desirable to have a thermal management system that is easy to install, can conform to non-flat (or geometrically complex) surfaces and able to perform during high temperature events. In published U.S. patent application 2005/0208203 A1 an aerogel film having a thickness of between 1 μm to 10 μm is described as a protective “thermal barrier” for a substrate in laser sintering. Of course such use is not only an ineffective solution for high temperature events (particularly of larger scale) but also impractical for installation.

In WO2005/120646a protective garment for firefighters is described that includes an insulation layer having fabric layers with aerogels there between. However, this insulation layer requires an external protective fire barrier layer since it cannot withstand direct high temperatures from fires.

Rigid tiles for space shuttles are described in U.S. 2002/0061396A1. These tiles contain a ceramic fiber matrix and aerogel particles partially filling said matrix and thus are very rigid, and must be prefabricated to fit a surface of interest.

Hence, an unfilled need still exists for a thermal management system with the aforementioned attributes.

### DETAILED DESCRIPTION

Within the context of embodiments of the present invention “aerogels” or “aerogel materials”, refer to gels containing air as a dispersion medium in a broad sense and include xerogels and cryogels in a narrow sense. Furthermore, the chemical composition thereof can be based on a metal oxide, organic compound (e.g. polymer) or both (hybrid organic-inorganic). Still further, they can be opacified with compounds such as but not limited to: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof. Also as used herein “aerogel blankets” or “blankets” refer to aerogel or aerogel materials of the present invention that are reinforced with a fibrous material. They can be fiber-reinforced with fibers that are polymer-based (e.g. polyester), inorganic-based (e.g. carbon, Polyacrylonitrile [PAN], O-PAN, quartz, basalt-based etc.) or both, in forms such as: a batting (fibrous or lofty), fibrous mats, felts, microfibers, chopped fibers, woven fabrics, unwoven fabrics or a combination thereof.

Examples of metal oxide-based aerogels include, but are not limited to silica, titania, zirconia, alumina, hafnia, yttria and ceria. The organic forms can be based on, but are not limited to, compounds such as, urethanes, resorcinol-formaldehydes, melamine-formaldehyde, phenol-furfural, polyimide, polyacrylates, chitosan, polymethyl methacrylate, members of the acrylate family of oligomers, trialkoxysilylterminated polydimethylsiloxane, polyoxyalkylene, polyurethane, polybutadiane, and a member of the polyether family of materials or combinations thereof. Examples of organic-inorganic hybrid aerogels are, but not limited to, silica-PMMA, silica-chitosan, silica-polyether or possibly a combination of the aforementioned organic and inorganic compounds. The published U.S. patent applications 2005/0192367 and 2005/0192366 teach a whole host of such hybrid organic-inorganic aerogel materials along with their blanket forms useful in embodiments of the present invention.

In embodiments of the present invention involve thermal management systems and methods of high temperature events such as but not limited to: detonation of explosives, fuel ignitions, fires and the like, is required. The systems comprise aerogels and can be applied to most any surface of a structure where a thermal management system is desired. In one aspect of the present invention, an insulating layer comprising at least one layer of fiber-reinforced aerogels is placed about or secured to the front surface (i.e. surface to be insulated) of a structure which may be a structural component of a larger assembly or independently standing.

During a high temperature event (absent any thermal management system), the heat flux initially reaches the front surface (also referred to as the “hot side”) of a structure raising the temperature the same. Consequently a temperature gradient is developed within the structure, and the temperatures will rise to a steady state if the heat flux is applied long enough. As heat passes through the structure to the back surface (also referred to as the “cold side”) its temperature eventually increases. Structural integrity of the structure may be compromised during this heating process, and/or the unexposed (“cold side”) of the structure may reach a temperature hot enough to ignite combustible material in the adjacent compartments, or cause failure in electronic systems.

In one aspect of the present invention, absent any thermal management system, high temperature events increase the temperature of the cold side of a structure. A structure may comprise a ceramic, metallic or composite material. In a further aspect of the present invention, absent any thermal management system, high temperature events increase the temperature of the cold side of a structure by at least about 50° C., at least about 100° C., at least about 150° C., at least about 200° C. or at least about 250° C. In another aspect of the present invention, absent any thermal management system, high temperature events increase the temperature of the cold side of a structure sufficiently to induce spontaneous combustion thereon.

In yet another aspect of the present invention, the high temperature events are characterized by a sustained heat flux of at least about 25 kW/m², at least about 30 kW/m², at least about 35 kW/m² or at least about 40 kW/m² over an area of at least about 1 cm² for at least 2 seconds. A heat flux of about 40 kW/m² has been associated with that arising from typical fires (Behavior of Charring Solids under Fire-Level Heat Fluxes; Milosavljevic, I., Suuberg, E. M.; NISTIR 5499; September 1994). In a special case the high temperature event is a heat flux of heat flux of about 40 kW/m² over a an area of at least about 2 in², for a duration of at least 1 minute.

A structure may or may not be flat. In some aspects of the present invention, the insulating layer is mated to a structure that is not flat, or is of complex geometry. These structures may be exemplified by, but not limited to, walls, wall corners, floor corners, ceiling corners, pipes, conduits etc. In some aspects of the present invention, the insulation layer comprises fiber-reinforced aerogels. For improved flexibility or conformability, aerogels can be reinforced with a batting a mat or a combination thereof, although other reinforcement forms may be similarly used. Aerogel composites reinforced with a fibrous batting, herein referred to as “blankets”, are particularly useful for applications requiring flexibility since they are conformable and provide excellent thermal conductivity. Aerogel blankets and similar fiber-reinforced aerogel composites are described in published U.S. patent application 2002/0094426A1 and U.S. Pat. Nos. 6,068,882, 5,789,075, 5,306,555, 6,887,563, and 6,080,475, all hereby incorporated by reference, in their entirety. In one aspect of the present invention the insulating layer comprises aerogel beads, particles or monoliths in combination with fiber forms.

Carbon based felts also have thermal insulating properties, and provide effective absorption of the infrared energy associated with a high temperature event. Carbon based felts are based on polyacrylonitrile (o-PAN), rayon, and pitch. These felts are treated to increase the carbon content of the fibers, in order to increase the heat stability and minimize off-gassing. Carbon based felts of at least 60 wt %, or at least 70 wt % or at least 80 wt % carbon content will provide effective thermal insulation properties when exposed to a high temperature events. These felts can be used with or without aerogel layers, and with or without facing materials.

Thermal management systems as presently described comprise at least one layer of fiber-reinforced aerogel. Based on the desired application, single or multiple layers (with various thicknesses) of fiber-reinforced aerogels may be used. The type of reinforcement used for the aerogels is preferably suitable for high temperature use.

### DESCRIPTION OF FIGURES

FIG. 1 Illustrates an insulating layer comprising an aerogel material only

FIG. 2 Illustrates an insulating layer comprising an aerogel material and ceramic paper

FIG. 3 Illustrates an insulating layer comprising an aerogel material with ceramic paper and retention layer

FIG. 4 Illustrates an insulating layer comprising an aerogel material with retention layer only

FIG. 5 Illustrates an insulating layer comprising an aerogel material with aluminum foil

FIG. 6 Illustrates an insulating layer secured with an adhesive and fabric

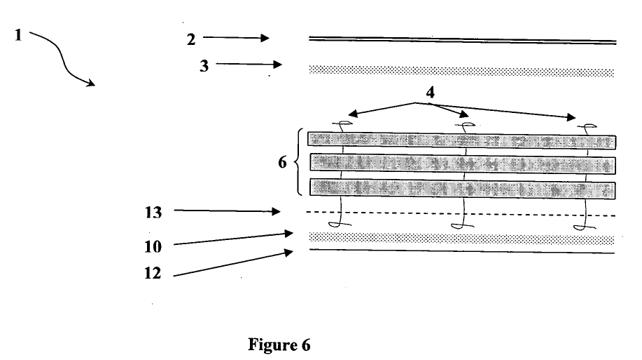

FIG. 7 Illustrates an insulating layer secured with adhesive only

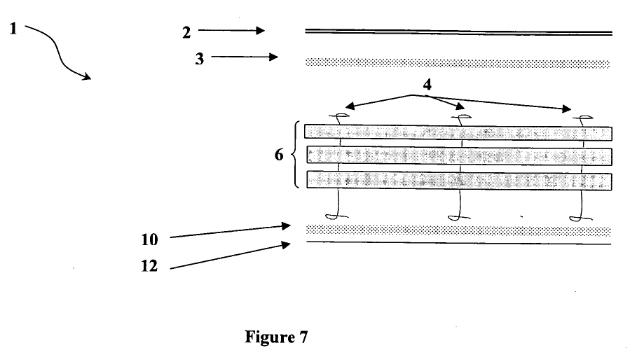

FIG. 8 Illustrates an insulating layer secured with posts

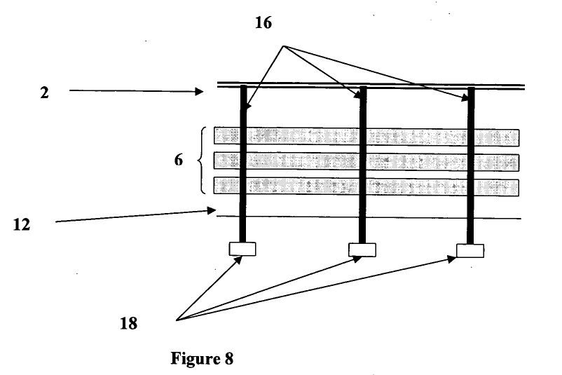

FIG. 9 Illustrates the time-temperature profile of an IMO and UL 1709 fire Curve

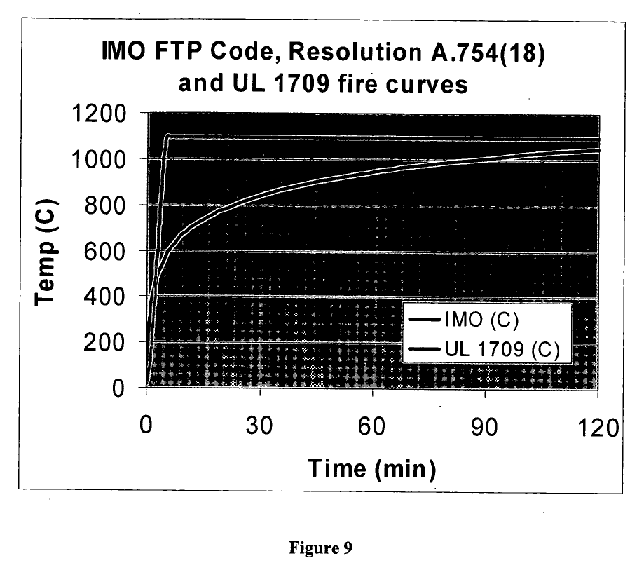

In the figures where relevant, the “insulated surface” refers to the surface where thermal management is desired. Stated differently, this is the surface to be insulated. For instance, in the case of a naval vessel, the steel or composite walls of the ship are surfaces where a thermal management system 1 is desired. Also in every figure it is implied that the aerogel materials is bonded to the insulated surface with posts, screws, rivets, tags, adhesives (with or without a fabric layer) or a combination thereof.

In a simple embodiment, an insulating layer comprising at least one layer of fiber reinforced aerogel 6 is affixed to a surface where thermal management 2 is desired. In a further embodiment, a supporting material such as a woven (or non-woven) fabric 8,13, or a scrim, can be placed between the fiber-reinforced aerogel and a surface where thermal management is desired to enhance bonding. Another method of securing the insulating layer is impalement of the insulating material with a post 16 protruding form the insulated surface and capped 18 at the other side of the insulated material. In applications where multiple plies of aerogels are used (or multiple plies including at least one aerogel layer), the plies can be held together using any combination of the following: an adhesive layer 10,3, metallic/ceramic thread stitching or other fastening mechanism 4 such as plastic tags or rivets. Using plastic tags to hold plies of material together is particularly advantageous since they are easy to apply and pose no issues after burning away (due to excessive heat) since the plies of material will have been already held in place between the facing 12 and the insulated surface.

A retention layer 11 may optionally be used to provide additional structural security. For example a metallic screen such as a stainless steel, galvanized steel and other iron alloys can be used to secure the aerogel plies and prevent shifting without compromising any thermal conductivity of the insulation layer. Alternatively, a flame stopping material such as an aluminoborosilicate material layer from 3M Inc. under product name Nextel™ can be used to protect the aerogel material and provide additional structural integrity.

Additional thermal protection can be derived from using ceramic papers such as Fiberfrax970® from Unifrax Inc. This class of material comprises alumino-silicate fibers wet-laid with a latex binder system to form a randomly oriented matrix. These products are flexible, light weight, and possess excellent thermal characteristics. Furthermore, an outer facing placed at the outer most surface of the insulation layer, can optionally be employed for preventing the aerogel material from shifting as well as to provide additional insulation, and enhanced aesthetic appearance. For example, in a naval vessel a marine board constructed from a coated fiberglass material may serve as the outer facing. The facing can be directly bonded to the aerogel via an adhesive with or without an intermediate layer (e.g. a fabric).

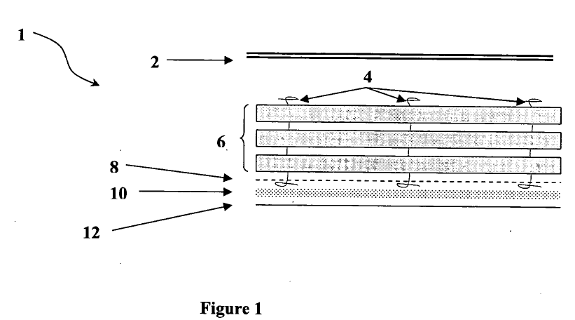

In FIG. 1 at least one layer of fiber-reinforced aerogel is bonded to a facing using a woven fiberglass material and an adhesive. If more than one layer of aerogel material is used, they can be fastened to each other using tags, metallic/ceramic stitching or rivets. Furthermore, a combination of reinforced and non-reinforced aerogels may be used. In this embodiment, at least one layer of fiber-reinforced aerogel with any reinforcement can be incorporated into the insulating layer using any combination of the following: an adhesive layer, metallic or ceramic thread stitching or a fastening mechanism such as plastic tags. Optionally an outer facing layer can be glued directly onto the aerogel or to an intermediate layer such as a woven (or non-woven) fabric for better adhesion, between the aerogel and the facing.

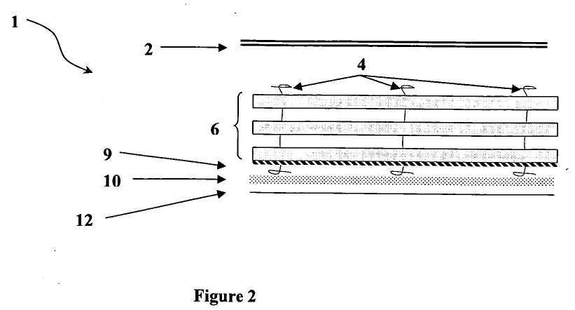

As in FIG. 2, at least one layer of fiber-reinforced aerogel material is shielded with a ceramic paper 9 material. In this particular embodiment, a layer of ceramic paper such as Fiberfrax970 can be used to provide an initial thermal barrier for the aerogel material and also assist in keeping the aerogel layers from displacing. The entire structure is fastened as in the previous embodiment. The porosity of the ceramic layer may also provide secondary benefits such as increased radiant heat protection.

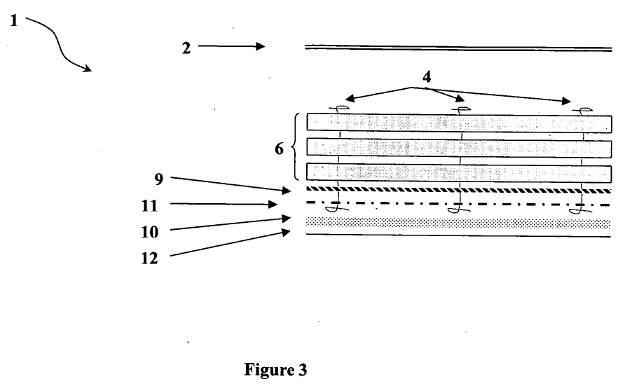

In this embodiment, illustrated in FIG. 3, at least one layer of fiber-reinforced aerogel material is faced with a ceramic layer such as Fiberfrax 970 paper from Unifrax. The ceramic paper and aerogel material is held by a retention layer such as a metallic screen or an aluminoborosilicate material such as Nextel. The entire structure is secured as in the previous embodiments.

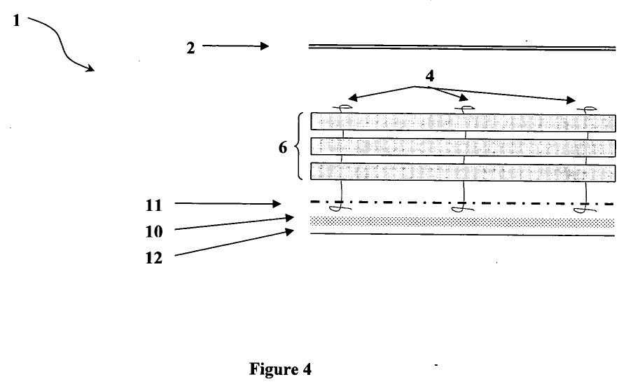

FIG. 4 illustrates the thermal management system where the fiber-reinforced aerogel is held in place with a retention layer that is a metallic screen or an aluminborosilicate material such as Nextel. Other high-temperature materials that may be used as retention layer include woven silica cloth, high temperature fiberglass such as S-Glass, and metal screens. These products could be coated and also serve as the outer facing material, creating a less extensive, lighter weight construction. In some instances direct exposure of aerogel materials to high thermal events is effectively countered by choosing an appropriate aerogel structure/reinforcement, such as a quartz-fiber reinforced form in this case. The entire structure can be secured as in the previous embodiments.

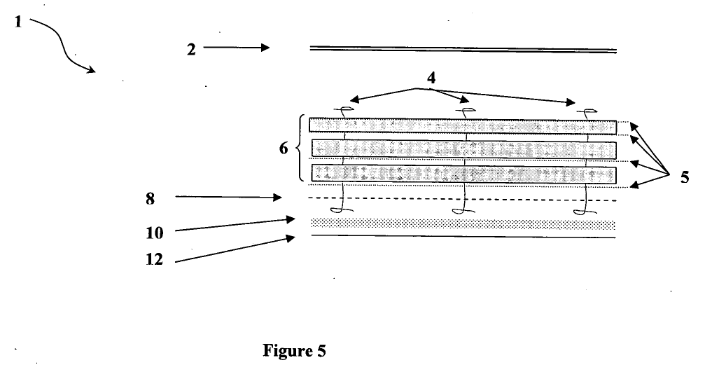

In order to provide additional thermal barriers within the insulating system, layers of aluminum foil 5, as illustrated in FIG. 5, can be used. In this embodiment, at least one layer of aluminum foil is placed between each layer of fiber-reinforced aerogel material to provide a barrier to radiant heat as well as oxygen thereby reducing the probability of combustion at higher temperatures. The thickness of the aluminum foil layer is preferably greater than 0.2 mil and more preferably greater than 0.4 mil. The entire structure can be secured as in the previous embodiments.

In another embodiment, an outer layer of quartz or ceramic fiber-reinforced aerogel is secured to at least one layer of carbon fiber reinforced aerogel. The benefit of this arrangement is the structural integrity provided by the outer layer under high thermal events, thus acting as a retention layer and an insulating layer.

Often the aerogel blankets are opacified, to block radiant heat from reaching the surface behind the aerogel. Examples of opacifying compounds include but are not limited to: as but not limited to B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof. The opacified aerogel is also an efficient emitter of radiant heat.

In some instances, it would be beneficial to have unopacified aerogel layers, separated by a layer of a high reflectivity foil, such as Aluminum. For instance, an unopacified aerogel with radiant heat reflective interlayers such as aluminum foils, may be economically advantageous to make or use versus its opacified counter part. The unopacified aerogel layers would serve to insulate the foils from conductive heat flow, which would help keep them intact. The radiant energy would travel through the aerogel layers, where it would be reflected by the foil layers. By having multiple layers, the time to failure could be increased substantially. Unopacified quartz, glass, or ceramic based aerogel blankets that might perform better at high temperatures can also be easily produced. An effective construction could also result from alternating layers of opacified and unopacified aerogel blankets, which would prevent direct exposure of lower layers to the radiant source, and serve as a buffer type layer if the foils failed.

In a preferred embodiment, the insulating layer protects a structure surface to be insulated during a high temperature event such that temperature of the hot side or the cold side of the structure does not increase more than about 250° C., more than about 200° C. more than about 150° C. more than about 100° C. more than about 50° C. or more than about 25° C.

In an embodiment the insulation layer comprises an intumescent coating. Such coatings can provide added benefits due to their expansion behavior in fires. FF88® and Pyroblok™ are two non-limiting examples.

What is claimed is:

1. A thermal management system for high temperature events comprising:
an insulating layer comprising at least one layer of fiber-reinforced aerogel,
said insulating layer disposed about and conforming to a surface to be insulated.

2. The system of claim 1 wherein the insulating layer is able to protect the surface from a heat flux of at least about 25 kW/m² with a cross sectional area of at least about 1 cm² lasting for at least 2 seconds.

3. The system of claim 1 wherein the insulating layer can protect a metallic or composite surface from a high temperature event resembling the UL 1709 or the IMO FTP fire curve for at least 30 minutes.

4. The system of claim 1 wherein the surface to be insulated comprises at least one curvature.

5. The system of claim 1 further comprising a fastening mechanism for fastening the insulation layer to the surface to be insulated.

6. The system of claim 5 wherein said fastening mechanism is an adhesive, metallic/ceramic thread stitching, tags, rivets posts or a combination thereof.

7. The system of claim 5 wherein the fastening mechanism comprises an adhesive layer and a fabric layer.

8. The system of claim 1 wherein the aerogel comprises silica, titania, zirconia, alumina, hafnia, yttria, ceria, nitrides, carbides or combinations thereof.

9. The system of claim 1 wherein the fiber-reinforcement comprises a batting, a mat, a felt or a combination thereof.

10. The system of claim 1 wherein the fiber-reinforcement comprises carbon fibers, substantially carbonized fibers, quartz fibers, basalt-based fibers or a combination thereof.

11. The system of claim 1 wherein the aerogel comprises B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof.

12. The system of claim 1 wherein the insulating layer further comprises at least one layer of ceramic paper.

13. The system of claim 1 wherein the insulating layer further comprises at least one layer of a metal or metallic screen.

14. The system of claim 1 wherein the insulating layer further comprises at least one layer of radiation reflecting material.

15. The system of claim 14 wherein the radiation reflecting material is aluminum.

16. The system of claim 1 wherein the insulating layer further comprises an intumescent coating.

17. The system of claim 1 wherein the insulating layer further comprises a layer of carbon felt.

18. A method for thermal management of high temperature events comprising: placing an insulating layer comprising at least one layer of fiber-reinforced aerogel, said insulating layer disposed about and conforming to a surface to be insulated.

20. The method of claim 18 wherein the insulating layer is able to protect the surface from a heat flux of at least about 25 kW/m² with a cross sectional area of at least about 1 cm² lasting for at least 2 seconds.

21. The method of claim 18 wherein the insulating layer can protect a metallic or composite surface from a high temperature event resembling the UL 1709 or the IMO FTP fire curve for at least 30 minutes.

22. The method of claim 18 wherein the surface to be insulated comprises at least one curvature.

23. The method of claim 18 further comprising a step of fastening the insulation layer to the surface to be insulated.

24. The method of claim 23 wherein the fastening is carried out with an adhesive, metallic/ceramic thread stitching, tags, rivets posts or a combination thereof.

25. The method of claim 23 wherein the fastening is carried out with an adhesive layer and a fabric layer.

26. The method of claim 18 wherein the aerogel comprises silica, titania, zirconia, alumina, hafnia, yttria, ceria, nitrides, carbides or combinations thereof.

27. The method of claim 18 wherein the fiber-reinforcement comprises a batting, a mat, a felt or a combination thereof.

28. The method of claim 18 wherein the fiber-reinforcement comprises carbon fibers, substantially carbonized fibers, quartz fibers, basalt-based fibers or a combination thereof.

29. The method of claim 18 wherein the aerogel comprises B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or mixtures thereof.

30. The method of claim 18 wherein the insulating layer further comprises at least one layer of ceramic paper.

31. The method of claim 18 wherein the insulating layer further comprises at least one layer of a metal or metallic screen.

32. The method of claim 1 wherein the insulation layer further comprises at least one layer of radiation reflecting material.

33. The method of claim 32 wherein the radiation reflecting material is aluminum.

34. The method of claim 18 wherein the insulation layer further comprises an intumescent coating.

35. The system of claim 1 wherein the insulating layer further comprises a layer of carbon felt.

36. A method of providing fire protection comprising: placing at least one layer of fiber-reinforced aerogel between a structure exposed to fire and a surface to be insulated.

37. The method of claim 38 wherein fire generates a heat flux of at least about 25 kW/m² over a cross-sectional area of at least about 1 cm².

38. The method of claim 38 further comprising, placing a fire retardant, fire suppressant or fire barrier material on at least one surface of said aerogel material.

39. A fire shield comprising at least one layer of fiber-reinforced aerogel l to be placed between a structure exposed to fire and a surface to be insulated.

40. The fire shield of claim 40 wherein the fire generates a heat flux of at least about 25 kW/m² over a cross-sectional area of at least about 1 cm².

41. The fire shield of claim 38 further comprising a fire retardant material, fire suppressant or fire barrier material on at least one surface of said aerogel material.
